(19) United States
(12) Patent Application Publication
(10) Pub. No.: US 2009/0243920 A1
(43) Pub. Date: Oct. 1, 2009

(54) POSITIONING METHOD, PROGRAM, AND POSITIONING APPARATUS

(75) Inventors: Kumar ANAND, Shiojiri (JP); Rama SANJAY, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/413,076

(22) Filed: Mar. 27, 2009

(30) Foreign Application Priority Data
Apr. 1, 2008 (JP) 2008-094954

(51) Int. Cl. G01S 5/14

(52) U.S. Cl. 342/357.04

(57) ABSTRACT

A positioning method adapted to perform interactive mixing model calculation (IMM calculation) for combining outputs of a plurality of Kalman filter processes while applying weighting of given model probabilities to the outputs in a positioning apparatus, includes the steps of (a) calculating a first likelihood index value of a first Kalman filter process, (b) calculating a second likelihood index value of a second Kalman filter process, (c) calculating a relative value of the first and second likelihood index values, (d) calculating a first model probability corresponding to the first Kalman filter process and a second model probability corresponding to the second Kalman filter process using the relative value, and (e) combining outputs of the first and second Kalman filter processes using the first and second model probabilities to execute the positioning.

Japanese Patent Application No. 2008-094954 filed on Apr. 1, 2008, is hereby incorporated by reference in its entirety.

### BACKGROUND

1. Technical Field

The present invention relates to, for example, a positioning method for a positioning apparatus assuming each Kalman filter process as a model, and executing an IMM calculation for combining the processing outputs of the Kalman filter processes while applying weighting of predetermined model probabilities, thereby performing a positioning calculation.

2. Related Art

As a positioning system using satellites, a global positioning system (GPS) is widely known, and is used as a positioning apparatus incorporated in, for example, a portable phone or a vehicle navigation system. In the GPS, there is performed the positioning calculation for obtaining values of four parameters, namely three-dimensional coordinate values representing the location of the positioning apparatus having the positioning system therein and a clock error, based on the information such as the locations of a plurality of GPS satellites or pseudo-ranges between the GPS satellites and the positioning apparatus, thereby determining the present location of the positioning apparatus.

As for the positioning calculation, there are known positioning calculation using a least-squares method and positioning calculation using a Kalman filter. Further, as a technology applying the positioning calculation using a Kalman filter, there is known an Interactive Mixing Model calculation (hereinafter referred to as “IMM calculation”) for preparing a plurality of Kalman filter models corresponding to moving states of the positioning apparatus to execute the positioning calculation for each of the models, and combining the results of the positioning calculations to determine the positioned location (e.g., “Estimation with Applications to Tracking and Navigation” by Yaakov Bar-Shalom, X. Rong Li, Thiagalingam Kirubarajan (U.S.), JOHN WILEY & SONS INC, 2001, pp. 92-93, 453-457).

In the positioning using the IMM calculation, the likelihood of an external observation amount to be an input value of the Kalman filter (hereinafter referred to as “likelihood”) its calculated from a function along a normal distribution (Gaussian distribution) called a likelihood function, and the probability of each of the Kalman filters (hereinafter referred to as a “model probability”) is calculated using the likelihood thus calculated. Then, the processing outputs of the respective Kalman filters are combined using the model probabilities thus calculated, thereby obtaining the present location of the positioning apparatus.

However, since the likelihood function is expressed by an exponential (EXP) function, if the exponential part of the EXP function becomes a very small value (e.g., −20 or below), the likelihood comes infinitely closer to 0, and if it is attempted to calculate it with a computer, it returns a 0 after all due to the numerical range the computer can calculate. Since the model probability is calculated using the likelihood, if the likelihood becomes 0, correct calculation of the model probability is not achievable, and as a result, there arises a big problem that it is not achievable to obtain the positioning location.

### SUMMARY

Some aspects of the invention have an advantage of solving the problem described above.

A first aspect of the invention is directed to a positioning method adapted to perform an interactive mixing model calculation (IMM calculation) for combining outputs of a plurality of Kalman filter processes while applying weighting of given model probabilities to the outputs in a positioning apparatus, including the steps of (a) calculating a first likelihood index value of a first Kalman filter process, (b) calculating a second likelihood index value of a second Kalman filter process, (c) calculating a relative value of the first and second likelihood index values, (d) calculating a first model probability corresponding to the first Kalman filter process and a second model probability corresponding to the second Kalman filter process using the relative value, and (e) combining outputs of the first and second Kalman filter processes using the first and second model probabilities to execute the positioning.

Further, another aspect of the invention is directed to a positioning apparatus adapted to perform an interactive mixing model calculation (IMM calculation) for combining outputs of a plurality of Kalman filter processes while applying weighting of given model probabilities to the outputs including a first index value calculation section adapted to calculate a first likelihood index value of a first Kalman filter process, a second index value calculation section adapted to calculate a second likelihood index value of a second Kalman filter process, a relative value calculation section adapted to calculate a relative value of the first and second likelihood index values, a model probability calculation section adapted to calculate a first model probability corresponding to the first Kalman filter process and a second model probability corresponding to the second Kalman filter process using the relative value, and a positioning section adapted to combine outputs of the first and second Kalman filter processes using the first and second model probabilities to execute the positioning.

According to the first aspect and the related aspect of the invention, the likelihood index value of each of the Kalman filter processes is calculated, and the relative values of the likelihood index values between the Kalman filter processes are calculated. Further, the model probability of each of the Kalman filter processes is calculated using the relative values thus calculated, and the processing outputs of the respective Kalman filter processes are combined using the model probabilities, thereby calculating the location.

Here, the likelihood index value denotes the exponential part of the likelihood function for calculating the likelihood of an external observation amount to be the input value of the Kalman filter. Although the model probability in the IMM calculation can be calculated based on the likelihood of the external observation value calculated using the likelihood index value, however, if the likelihood index value has a very small value, the likelihood returns 0 when attempting to calculate it with a computer due to the numerical range the computer can calculate, and it is not achievable to correctly obtain the model probability.

In order for solving the problem, the inventors have found the fact that the model probability can correctly be obtained using the relative value of the likelihood index values from a plurality of Kalman filter processes instead of directly using the likelihood index values. This measure is taken focusing on the fact that the relative value of the likelihood index values becomes in general the value in the vicinity of 0 even if the individual likelihood index value is a very small value, and when performing calculation while providing the exponential function with the relative value, the result does not become 0. According to the principle described above, it becomes possible to correctly calculate the model probability, and as a result, it becomes possible to realize calculation of the correct positioning location.

Further, as a second aspect of the invention, it is possible in the first aspect of the invention that in step (d), the model probabilities are calculated using a predetermined exponential function having a value decreasing as the relative value becomes smaller.

According to the second aspect of the invention, the model probabilities are calculated using the exponential function (e.g., an EXP function having the relative value of the likelihood index values as a variable) having the value decreasing as the relative value of the likelihood index values from the Kalman filter processes becomes smaller.

Further, as a third aspect of the invention, it is possible in the second aspect of the invention that the step (f) to determine whether or not the value of the predetermined exponential function calculated using the relative value satisfies a predetermined limit value condition, which is a condition indicating an equivalent value of a limit value, and the step (d) to calculate the first and second model probabilities using the value of the exponential function as a limit value when the predetermined limit value condition is satisfied.

According to the third aspect of the invention, in the case in which the value of the exponential function calculated using the relative value of the likelihood index values from the Kalman filter processes satisfies the limit value condition, the model probabilities are calculated assuming the value of the exponential function as the limit value. Thus, the model probabilities can be obtained by a computer even in the case in which the value of the exponential function converges to 0 or diverges to infinity.

Further, as a fourth aspect of the invention, it is possible in the third aspect of the invention that the predetermined limit value condition includes a condition indicating an equivalent value of a maximum value and a condition indicating an equivalent value of a minimum value, and step (d) includes the step of setting the first and second model probabilities to be either one of 1 and 0 in accordance with whether the condition indicating the equivalent value of the maximum value is satisfied or the condition indicating the equivalent value of the minimum value is satisfied in the case in which the predetermined limit value condition is satisfied.

According to the fourth aspect of the invention, the model probability is set to be 1 or 0 in accordance with whether the value of the exponential function calculated using the relative value of the likelihood index value from the Kalman filter processes satisfies the equivalent value of the maximum value or the equivalent value of the minimum value.

Further, as a fifth aspect of the invention, it is possible in any one of the first through the fourth aspects of the invention that the first Kalman filter process is a Kalman filter process corresponding to a constant velocity movement state of the positioning apparatus.

According to the fifth aspect of the invention, the Kalman filter process corresponding to the constant velocity movement state is performed as the movement state of the positioning apparatus as the first Kalman filter process, and the processing outputs of the first and second Kalman filter processes are combined.

Further, as a sixth aspect of the invention, it is possible that a positioning method adapted to perform an interactive mixing model calculation (IMM calculation) for combining outputs of a plurality of Kalman filter processes while applying weighting of given model probabilities to the outputs in a positioning apparatus, includes the steps of (a) calculating a first likelihood index value of a first Kalman filter process, (b) calculating a second likelihood index value of a second Kalman filter process, (g) calculating a third likelihood index value of a third Kalman filter process, (h) calculating relative values of the first, second, and third likelihood index values, (i) calculating a first model probability corresponding to the first Kalman filter process, a second model probability corresponding to the second Kalman filter process, and a third model probability corresponding to the third Kalman filter process using the relative values, and (j) combining outputs of the first, second, and third Kalman filter processes using the first, second, and third model probabilities to execute the positioning.

According to the sixth aspect of the invention, the likelihood index value of each of the Kalman filter processes is calculated, and the relative values of the likelihood index values between the Kalman filter processes are calculated. Further, the model probability of each of the Kalman filter processes is calculated using the relative values thus calculated, and the processing outputs of the respective Kalman filter processes are combined using the model probabilities, thereby calculating the location.

Further, as a seventh aspect of the invention, it is possible in the sixth aspect of the invention that the first Kalman filter process is a Kalman filter process corresponding to a stopped state of the positioning apparatus, the second Kalman filter process is a Kalman filter process corresponding to a constant velocity movement state of the positioning apparatus, and the third Kalman filter process is a Kalman filter process corresponding to a constant acceleration movement state of the positioning apparatus.

According to the seventh aspect of the invention, three types of Kalman filter processes corresponding to the stopped state, the constant velocity movement state, and the constant acceleration movement state are executed as the movement states of the positioning apparatus, and the processing outputs of these Kalman filter processes are combined.

Further, as an eighth aspect of the invention, it is possible to configure a computer-readable recording medium storing a program for allowing a computer incorporated in the positioning apparatus to execute the positioning method according to any one of the first through seventh aspects.

### BRIEF DESCRIPTION OF THE DRAWINGS

The invention will be described with reference to the accompanying drawings, wherein like numbers reference like elements.

FIG. 1 is an explanatory diagram of an IMM.

FIG. 2 is a flowchart showing the flow of the IMM calculation process.

FIG. 3 is a flowchart showing the flow of the IMM calculation process.

FIG. 4 is a diagram showing a result of an experiment for obtaining the model probability using a related-art method.

FIG. 5 is a diagram showing a result of an experiment for obtaining the model probability using a method of an embodiment.

FIG. 6 is an explanatory diagram of the model probability calculation using the related-art method.

FIG. 7 is an explanatory diagram of the model probability calculation using the method of the embodiment.

FIG. 8 is a block diagram showing a functional configuration of a portable phone.

FIG. 9 is a diagram showing an example of data stored in a ROM of a baseband processing circuit section.

FIG. 10 is a diagram showing an example of data to be stored in a RAM of the baseband processing circuit section.

FIG. 11 is an explanatory diagram of the IMM in the embodiment.

FIG. 12 is a diagram showing an example a data configuration of measurement data by captured satellite.

FIG. 13 is a flowchart showing the flow of the baseband processing.

### DESCRIPTION OF EXEMPLARY EMBODIMENTS

### 1. Principle

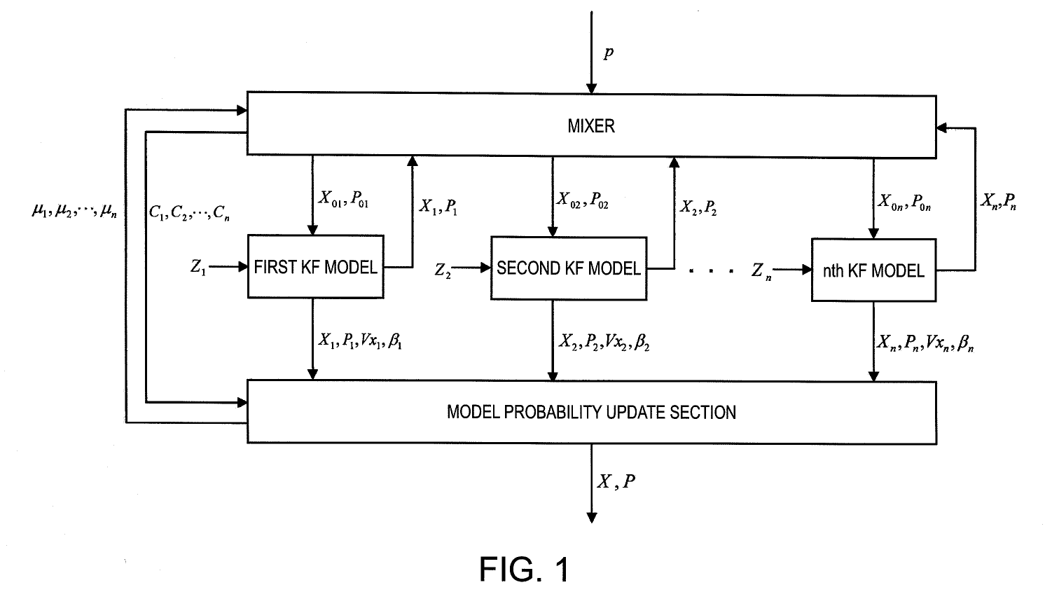

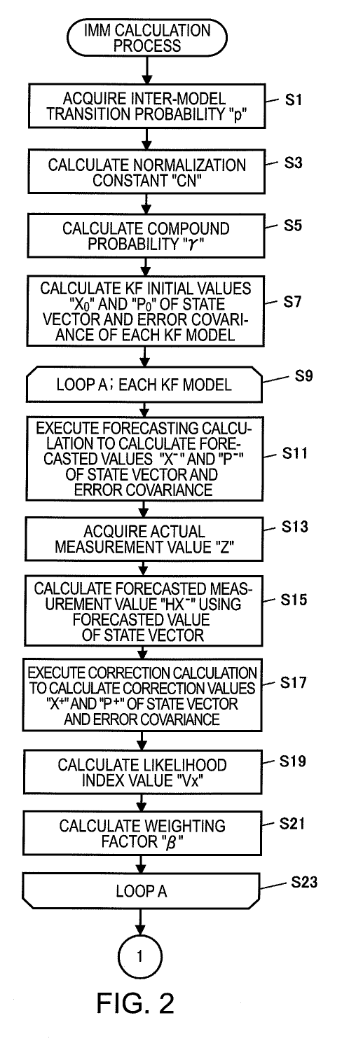

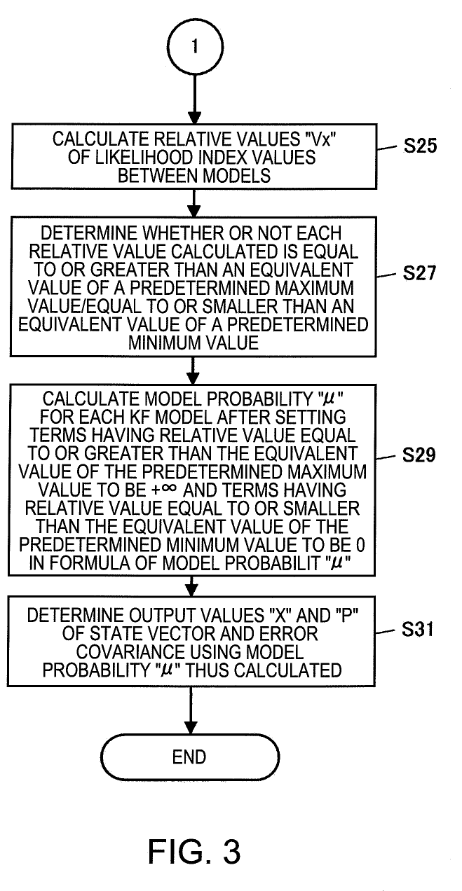

FIG. 1 is a diagram for explaining an outline of the Interactive Mixing Model (hereinafter referred to as “IMM”) in the present embodiment. Although the explanation will be presented here assuming that the IMM calculation is realized by calculation in a plurality of processing circuit blocks for the sake of better understanding of the explanation, it is also possible to realize the IMM calculation by a single processor, and in the explanations of the processing flow shown in FIGS. 2 and 3, it is assumed that the IMM calculation is executed by the single processor.

The IMM is a model combining processing outputs of a plurality of Kalman filter models (hereinafter referred to as a “KF model”) with weights called model probability μ, thereby determining a final output value. FIG. 1 shows the IMM including an n number of KF models, namely the first through nth KF models.

Further, although the explanation will be presented assuming that a single external observation amount Z (corresponding to an actual measurement value in the present embodiment) is given to each of the KF models for simplifying the explanation, the same is applied to the case in which a plurality of actual measurement values is given. The actual measurement value can appropriately be set in accordance with the system to which the IMM calculation is applied.

In the IMM calculation, a mixer calculates initial values X₀: X₀₁, X₀₂, . . . , X₀ₙ and P₀: P₀₁, P₀₂, . . . , P₀ₙ of a state vector and an error covariance of each of the KF models in the present calculation using an inter-model transition probability p representing the transition probability between the KF models, the model probabilities μ: μ₁, μ₂, . . . μₙ updated by a model probability update section in the previous step, and calculation values X: X₁, X₂, . . . , Xₙ of the state vectors and calculation values P: P₁, P₂, . . . , Pₙ of the error covariance calculated in each of the KF models, and outputs the calculation results to the corresponding KF models, respectively.

Further, the mixer calculates constants called normalization constants CN: C₁, C₂, . . . , Cₙ using the inter-model transition probability p, and the model probabilities μ updated by the model probability update section in the previous step, and outputs them to the model probability update section.

Each of the KF models executes forecasting calculation and correction calculation similarly to the known Kalman filter using the initial values X₀ and P₀, input from the mixer and the actual measurement value Z: Z₁, Z₂, . . . , Zₙ, thereby calculating the present calculation values of the state vector and the error covariance, and outputting them to the model probability update section. Further, each of the KF models calculates a value called a likelihood index value Vx: Vx₁, Vx₂, . . . , Vxₙ, and a value called a weighting factor β: β₁, β₂, . . . , βₙ, and outputs them to the model probability update section.

The likelihood index value Vx is a value represented as the exponential part of the likelihood function as a function for calculating the likelihood (hereinafter referred to as “likelihood”) of the actual measurement value Z. Further, the weighting factor β is a value represented as the coefficient part of the likelihood function.

The model probability update section newly calculates and updates the model probability μ using the normalization constants CN input from the mixer, and the likelihood index value Vx and the weighting factor β input from each of the KF models. Further, by respectively combining the state vectors and the error covariances input from the KF models while applying weighting of the model probabilities μ thus calculated, output value X of the state vector and output value P of the error covariance are calculated.

Then, the flow of the process in the case of realizing the IMM calculation with a single processor will be explained with reference to actual formulas. In the following formulas, it is assumed that a subscript j of each variable represents the fact that the variable corresponds to the jth KF model.

FIG. 2 is a flowchart showing a flow of the IMM calculation process executed by a central processing unit (CPU) as a kind of processor.

Firstly, the CPU obtains the inter-model transition probability p (step S1). The inter-model transition probability p is given as an n×n matrix shown in the following formula (1).

$$p = [ \begin{matrix}{p}_{11} & {p}_{12} & & \\ {p}_{21} & {p}_{22} & & \\ & & ⋰ & \\ & & & {p}_{nn}\end{matrix} ] \qquad ( 1 )$$

The component pₙₘ of the matrix represents the probability of the transition from the nth KF model to the mth KF model. For example, the component p₁₁ of the matrix represents the probability of the transition from the first KF model to the first KF model (itself), and the component p₁₂ of the matrix represents the probability of the transition from the first KF model to the second KF model. Further, the value obtained by totalizing the components in each row i is 1. In other words, pᵢ₁+pᵢ₂+ . . . +pᵢₙ=1 is satisfied.

Subsequently, the CPU calculates the normalization constant CN along the following formula (2) (step S3).

$$CN = [ \begin{matrix}{C}_{1} \\ {C}_{2} \\ ⋮ \\ {C}_{n}\end{matrix} ] = {[ \begin{matrix}{p}_{11} & {p}_{12} & & \\ {p}_{21} & {p}_{22} & & \\ & & ⋰ & \\ & & & {p}_{nn}\end{matrix} ]}^{T} \cdot [ \begin{matrix}{μ}_{1} \\ {μ}_{2} \\ ⋮ \\ {μ}_{n}\end{matrix} ] \qquad ( 2 )$$

As is understood from the formula (2), the normalization constant CN is represented by a product of a transposed matrix of the inter-model transition probability p and the model probability μ.

Subsequently, the CPU calculates a compound probability γ along the following formula (3) (step S5).

$$γ = [ \begin{matrix}{γ}_{11} & {γ}_{12} & & \\ {γ}_{21} & {γ}_{22} & & \\ & & ⋰ & \\ & & & {γ}_{nn}\end{matrix} ] = [ \begin{matrix}\frac{{p}_{11} {μ}_{1}}{{C}_{1}} & \frac{{p}_{12} {μ}_{1}}{{C}_{2}} & & \\ \frac{{p}_{21} {μ}_{2}}{{C}_{1}} & \frac{{p}_{22} {μ}_{2}}{{C}_{2}} & & \\ & & ⋰ & \\ & & & \frac{{p}_{nn} {μ}_{n}}{{C}_{n}}\end{matrix} ] \qquad ( 3 )$$

As is understood from the formula (3), the compound probability γ is calculated using the components of the inter-model transition probability p, the components of the model probability μ, and the components of the normalization constant CN.

Subsequently, the CPU calculates an initial value X₀ of the state vector and an initial value P₀ of the error covariance in the KF process along the following formulas (4) and (5).

X₀ⱼ=X₁γ₁ⱼ+X₂γ₂ⱼ+ . . . +Xₙγₙⱼ (4)

P₀ⱼ=γ₁ⱼ[P₁+(X₁−X₀ⱼ)()^{T}]+γ₂ⱼ[P₂+(X₂−X₀ⱼ)()^{T}]+ . . . +γₙⱼ[Pₙ+(Xₙ−X₀ⱼ)()^{T}] (5)

Subsequently, the CPU executes the process of a loop A for each of the KF models (steps S9 through S23). In the loop A, the CPU executes forecasting calculation along the following formulas (6) and (7) to forecast the state vector and the error covariance (step S11).

Xⱼ⁻=φⱼX₀ⱼ (6)

Pⱼ⁻=φⱼP₀ⱼφⱼ^{T}+Qⱼ (7)

It should be noted that the subscript “−” represents that the value is a forecasted value. Further, φ and Q are matrices respectively called state transition matrix and process noise set for each of the KF models.

Subsequently, the CPU obtains the actual measurement value Z from the outside (e.g., a sensor for detecting an external observation amount) (step S13). Further, the CPU calculates the forecasted value (hereinafter referred to as a “forecasted measurement value”) of the external observation amount using the forecasted value X⁻ of the state vector forecasted in the step S11 (step S15). The forecasted measurement value is expressed by a product HX⁻ of a predetermined observation matrix H and the forecasted value X⁻ of the state vector.

Subsequently, the CPU executes a correction calculation to correct the state vector and the error covariance forecasted in the step S11 (step S17). Specifically, firstly a gain called a Kalman gain K is calculated along the following formula (8).

Kⱼ=Pⱼ⁻HⱼE[Vⱼ]⁻¹=Pⱼ⁻Jⱼ(HⱼPⱼ⁻Hⱼ^{T}+Rⱼ)⁻¹ (8)

It should be noted that E[·] represents an average value (expectation value). Further, R is a matrix called a measurement error matrix representing an error included in the actual measurement value Z.

Further, the CPU corrects the state vector and the error covariance using the actual measurement value Z and the forecasted measurement value HX⁻ along the following formulas (9) and (10).

Xⱼ=Xⱼ⁺=Xⱼ⁻+KⱼVⱼ=Xⱼ⁻+Kⱼ(Zⱼ−HⱼXⱼ⁻) (9)

Pⱼ=Pⱼ⁺=(I−KⱼHⱼ)Pⱼ⁻ (10)

It should be noted that the subscript “+” represents that the value is a correction value. Further, I denotes a unit matrix.

Subsequently, the CPU calculates the likelihood index value Vx along the following formula (11).

Vxⱼ=Vⱼ^{T}·E[Vⱼ]⁻¹·Vⱼ=(Zⱼ−HⱼXⱼ)^{T}(HⱼPⱼHⱼ^{T}+Rⱼ)⁻¹(Zⱼ−HⱼXⱼ) (11)

Further, the CPU calculates the weighting factor β along the following formula (12).

$${β}_{j} = \frac{1}{\sqrt{{( 2 π )}^{N} \vert E [ {V}_{j} ] \vert}} = \frac{1}{\sqrt{{( 2 π )}^{N} \vert {H}_{j} {P}_{j} {H}_{j}^{T} + {R}_{j} \vert}} \qquad ( 12 )$$

It should be noted that N represents the number of the actual measurement values thus obtained.

After executing the process corresponding to the steps S11 through S21 for all of the KF models, the CPU terminates the loop A. Subsequently, the CPU calculates relative values of the likelihood index values Vx in respective relative combinations of the KF models (step S25). For example, in the case in which there exist three KF models, namely first through third KF models, the values corresponding respectively to the six relative combinations Vx₁−Vx₂, Vx₂−Vx₁, Vx₁−Vx₃, Vx₃−Vx₁, Vx₂−Vx₃, and Vx₃−Vx₂ are calculated as the relative values of likelihood values.

Subsequently, the CPU determines whether or not each of the relative values calculated in the step S25 becomes equal to or greater than an equivalent value (e.g., +20) of the predetermined maximum value and whether or not it becomes equal to or smaller than an equivalent value (e.g., −20) of the predetermined minimum value (step S27).

Further, the CPU calculates the model probability μ for each of the KF models assuming that the term with the relative value determined to be equal to or greater than the equivalent value of the maximum value is infinity, and the term with the relative value determined to be equal to or smaller than the equivalent value of the minimum value is 0 in the denominator of the formula of the model probability μ given by the following formula (13-2) (step S29).

$$\begin{matrix} \begin{matrix}{μ}_{j} = \frac{{λ}_{j} {C}_{j}}{C} \\ = \frac{{λ}_{j} {C}_{j}}{{λ}_{1} {C}_{1} + {λ}_{2} {C}_{2} + … + {λ}_{n} {C}_{n}} \\ = \frac{{β}_{j} exp ( {Vx}_{j} ) {C}_{j}}{\begin{matrix}{β}_{1} exp ( {Vx}_{1} ) {C}_{1} + {β}_{2} exp ( {Vx}_{2} ) {C}_{2} + … + \\ {β}_{n} exp ( {Vx}_{n} ) {C}_{n}\end{matrix}}\end{matrix} & ( 13 \text{-} 1 ) \\ = \frac{1}{\begin{matrix}\frac{{β}_{1}}{{β}_{j}} exp ( {Vx}_{1} - {Vx}_{j} ) \frac{{C}_{1}}{{C}_{j}} + \frac{{β}_{2}}{{β}_{j}} exp ( {Vx}_{2} - {Vx}_{j} ) \\ \frac{{C}_{2}}{{C}_{j}} + … + 1 + … + \frac{{β}_{n}}{{β}_{j}} exp ( {Vx}_{n} - {Vx}_{j} ) \frac{{C}_{n}}{{C}_{j}}\end{matrix}} & ( 13 \text{-} 2 )\end{matrix}$$

More specifically, in the case in which there exists at least one term with the relative value equal to or greater than the maximum value, the model probability μ is set to be 0, while in the case in which all of the terms have the relative values equal to or smaller than the minimum value, the model probability μ is set to be 1.

It should be noted that λ in the formula (13-1) represents the likelihood given by the following formula (14), and C represents the normalization constant given by the following formula (15).

λⱼ=βⱼexp(−0.5(Vⱼ^{T}·E[Vⱼ]⁻¹·Vⱼ))=βⱼexp(Vxⱼ) (14)

C=λ₁C₁+λ₂C₂+ . . . +λₙCₙ (15)

Subsequently, the CPU determines the output values X and P of the state vector and the error covariance, respectively, using the model probability μ calculated in the step S29 along the following formulas (16) and (17) (step S31). Then, the CPU terminates the IMM calculation process.

X=X₁μ₁+X₂μ₂+ . . . +Xₙμₙ (16)

P=μ₁[P₁+(X₁−X)()^{T}]+μ₂[P₂+(X₂−X)()^{T}]+ . . . +μₙ[Pₙ+(Xₙ−X)()^{T}] (17)

### 2. Experimental Results

Experimental results of the case in which the model probability μ is calculated for each of the KF models in the case in which there are two KF models, a first KF model and a second KF model will hereinafter be explained. Here, the experiment was executed setting the likelihood index value Vx₁ of the first KF model to be −20, and the likelihood index value Vx₂ of the second KF model to be −21. In the case in which there are two KF models, the model probabilities μ₁ and μ₂ are calculated along the following formulas (18) and (19).

$$\begin{matrix}{μ}_{1} = \frac{{λ}_{1} {C}_{1}}{C} = \frac{{λ}_{1} {C}_{1}}{{λ}_{1} {C}_{1} + {λ}_{2} {C}_{2}} = \frac{{β}_{1} exp ( {Vx}_{1} ) {C}_{1}}{\begin{matrix}{β}_{1} exp ( {Vx}_{1} ) {C}_{1} + \\ {β}_{2} exp ( {Vx}_{2} ) {C}_{2}\end{matrix}} & ( 18 \text{-} 1 ) \\ = \frac{1}{1 + \frac{{β}_{2}}{{β}_{1}} exp ( {Vx}_{2} - {Vx}_{1} ) \frac{{C}_{2}}{{C}_{1}}} & ( 18 \text{-} 2 ) \\ {μ}_{2} = \frac{{λ}_{2} {C}_{2}}{C} = \frac{{λ}_{2} {C}_{2}}{{λ}_{1} {C}_{1} + {λ}_{2} {C}_{2}} = \frac{{β}_{2} exp ( {Vx}_{2} ) {C}_{1}}{\begin{matrix}{β}_{1} exp ( {Vx}_{1} ) {C}_{1} + \\ {β}_{2} exp ( {Vx}_{2} ) {C}_{2}\end{matrix}} & ( 19 \text{-} 1 ) \\ = \frac{1}{\frac{{β}_{1}}{{β}_{2}} exp ( {Vx}_{1} - {Vx}_{2} ) \frac{{C}_{1}}{{C}_{2}} + 1} & ( 19 \text{-} 2 )\end{matrix}$$

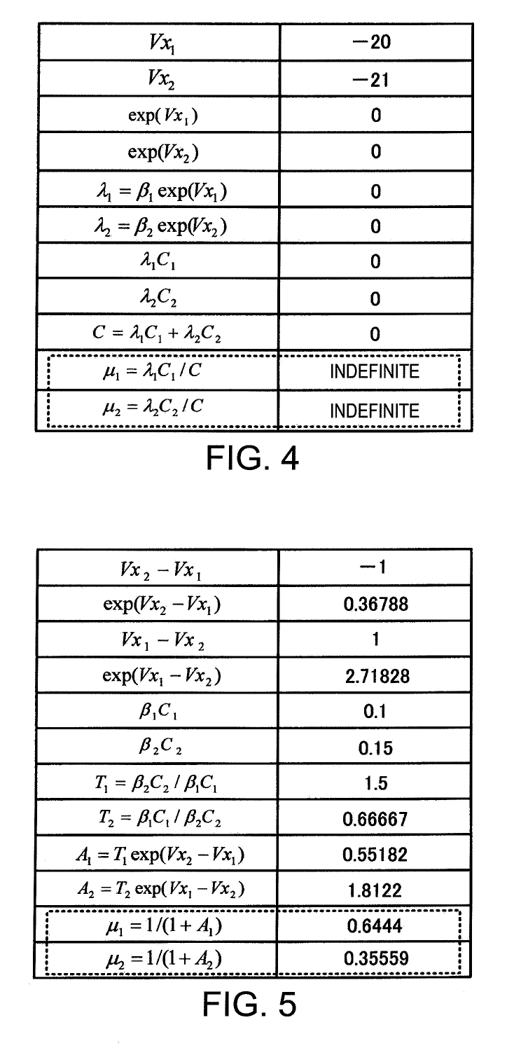

FIG. 4 is a diagram showing the values of the various parameters in the case in which the model probabilities μ₁ and μ₂ are calculated by the formulas (18-1) and (19-1) along the method of the related art. According to the results, since the likelihood λ₁ and λ₂ are both 0, λ₁C₁ and λ₂C₂ become 0, and C=λ₁C₁+λ₂C₂ becomes also 0. Since each of the denominators of the formulas (18-1) and (19-1) thus becomes 0, the model probabilities μ₁ and μ₂ are set to be indefinite.

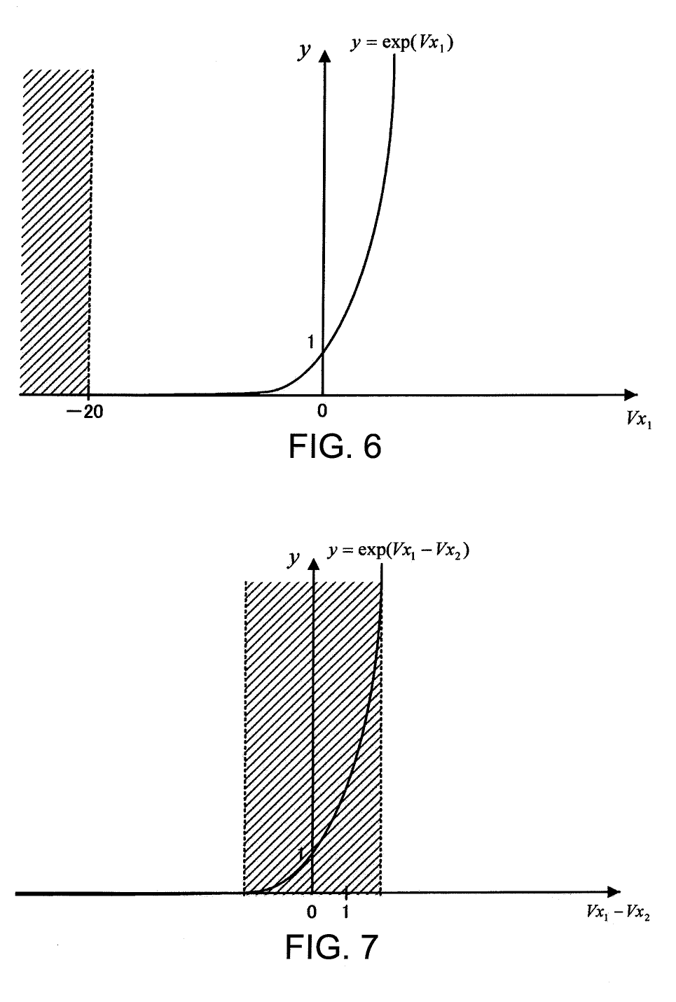

FIG. 6 qualitatively shows this condition. In the drawing, the horizontal axis represents Vx₁, and the vertical axis represents y=exp(Vx₁). In the experiment described above, the value of Vx₁ is −20, and according to this graph, it is understood that the value of y becomes approximately 0. Further, the value of Vx₂ is −21, and the same applies to this case.

In other words, the method of the related art has a problem that, if the likelihood index value Vx calculated for each of the KF models concentrates in a very small negative area (the hatched area shown in FIG. 6), the values of the EXP function become 0 due to the range of the numerical values, which can be calculated, and therefore, the likelihood λ calculated by the formula (14) becomes 0. If the likelihood becomes 0, it is not achievable to calculate the model probability μ along the formula (13-1).

FIG. 5 is a diagram showing the values of the various parameters in the case in which the model probabilities μ₁ and μ₂ are calculated by the formulas (18-2) and (19-2) along the method of the present embodiment. According to the results, it is understood that the model probabilities μ₁ and μ₂ are correctly obtained due to the calculation using the relative values Vx₁−Vx₂ and Vx₂−Vx₁ of the likelihood index values Vx₁ and Vx₂ instead of the likelihood index values Vx₁ and Vx₂.

FIG. 7 qualitatively shows this condition. In the drawing, the horizontal axis represents Vx₁−Vx₂, and the vertical axis represents y=exp(Vx₁−Vx₂). In the experiment described above, since the value of Vx₁ is −20 and the value of Vx₂ is −21, the value of Vx₁−Vx₂ becomes 1, and in this case, the value of y can be obtained correctly. Further, the value of Vx₂−Vx₁ becomes −1, and in this case, the value of y can also be obtained correctly.

The inventors focus attention on the point that the relative values of the likelihood index values concentrate in an area (the hatched area shown in FIG. 7) in the vicinity of 0 even if the likelihood index value Vx calculated for each of the KF models is a very small value. Further, the inventors have found that it is possible to obtain the model probability μ independently of the amplitude of the likelihood index value Vx by directly calculating the model probability μ from the relative values of the likelihood index values using the formula (13-2) obtained by developing and modifying the formula (13-1) without calculating the likelihood λ along the formula (14).

### 3. Description of the Embodiments

Hereinafter, preferred embodiments of the invention applied to a portable phone of a kind of electronic apparatus equipped with a positioning apparatus will be hereinafter explained. It should be noted that the scope of the invention is not limited to the specific examples unless specifically stated otherwise.

### 3-1. Functional Configuration

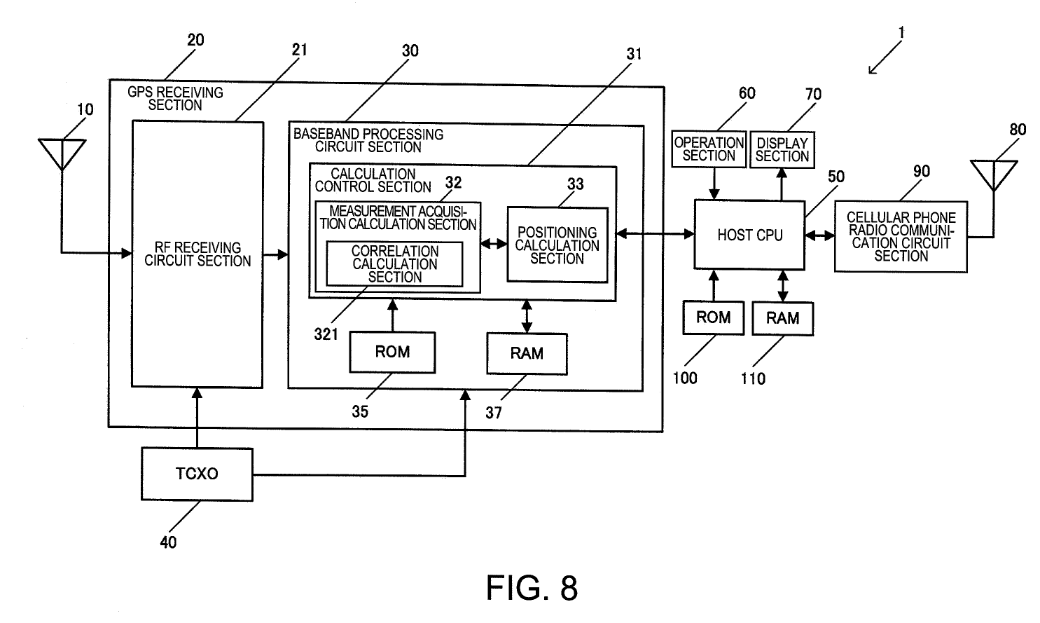

FIG. 8 is a block diagram showing a functional configuration of the portable phone 1 as a first embodiment according to the invention. The portable phone 1 is configured including a GPS antenna 10, a GPS receiving section 20, a temperature compensated crystal oscillator (TCXO) 40, a host central processing unit (CPU) 50, an operation section 60, a display section 70, a cellular phone antenna 80, a cellular phone radio communication circuit section 90, a read only memory (ROM) 100, and a random access memory (RAM) 110.

The GPS antenna 10 is an antenna for receiving radio frequency (RF) signals including the GPS satellite signal transmitted from GPS satellites, and outputs the signals thus received to the GPS receiving section 20. It should be noted that the GPS satellite signal is a communication signal of 1.57542 [GHz] modulated by the direct spread spectrum method with the pseudo random noise (PRN) code, which is a type of spread code unique to each of the satellites. The PRN code is a pseudo random noise code having a code length of 1023 chips as 1 PN frame, and a repetition period of 1 ms.

The GPS receiving section 20 is a positioning circuit for positioning the present location of the portable phone 1 based on the signal output from the GPS antenna 10, and a functional block corresponding to a so-called GPS receiver. The GPS receiving section 20 is configured including a radio frequency (RF) receiving circuit section 21, and a baseband processing circuit section 30. It should be noted that the RF receiving circuit section 21 and the baseband processing circuit section 30 can be manufactured separately as discrete large scale integration circuits (LSI), or manufactured integrally as one chip.

The RF receiving circuit section 21 is a processing circuit block for RF signals, and for dividing or multiplying the oscillation signal generated by the TCXO 40, thereby generating the oscillation signal for RF signal multiplication. Further, the RF receiving circuit section 21 multiplies the RF signal output from the GPS antenna 10 by the oscillation signal thus generated to down-convert the RF signal into an intermediate frequency signal (hereinafter referred to as an “intermediate frequency (IF) signal”), amplifies the IF signal, then converts it into a digital signal with an A/D converter, and outputs the digital signal to the baseband processing circuit section 30.

The baseband processing circuit section 30 is a circuit section for executing correlation processing or the like on the IF signal output from the RF receiving circuit section 21 to capture and extract the GPS satellite signal, and decoding the data to extract a navigation message, time information and the like and perform the positioning calculation. The baseband processing circuit section 30 is configured including a calculation control section 31, a ROM 35, and a RAM 37. Further, the calculation control section 31 is configured including a measurement acquisition calculation section 32 and a positioning calculation section 33.

It should be noted that the measurement acquisition calculation section 32 and the positioning calculation section 33 can be manufactured separately as discrete LSI, or manufactured integrally as one chip. Further, although in the present specific example, the explanation will be presented assuming that the positioning calculation of the present location itself is executed by the positioning calculation section 33, it is obvious that it is also possible to arrange that a part of or the entire process executed by the positioning calculation section 33 is executed by the host CPU 50.

The measurement acquisition calculation section 32 is a circuit section for performing capturing and tracking of the GPS satellite signal based on the received signal (the IF signal) output from the RF receiving circuit section 21, and is configured including a correlation calculation section 321. The measurement acquisition calculation section 32 obtains the information such as the reception frequency or code phase of the GPS satellite signal captured and tracked, and outputs the information to the positioning calculation section 33 as the actual measurement value.

The correlation calculation section 321 executes a coherent process for calculating the correlation between the PRN code included in the reception signal and the replica code using, for example, FFT calculation, and executes an incoherent process for accumulating the correlation values as the results of the coherent process for a predetermined number of seconds (e.g., for one second) to calculate an integrated correlation value, thereby capturing the GPS satellite signal. The replica code denotes a signal generated spuriously for simulating the PRN code included in the GPS satellite signal to be captured.

If the GPS satellite signal to be captured is correct, the PRN code included in the GPS satellite signal and the replica code match with each other (capture has been successful), and if it is wrong, they do not match (capture has failed). Therefore, it is possible to determine whether or not the capture of the GPS satellite signal is successful by judging the peak of the integrated correlation value thus calculated, and by executing correlation calculation with the same reception signal while sequentially changing the replica codes, it becomes possible to capture the GPS satellite signal.

Further, the correlation calculation section 321 executes the coherent process described above while changing the frequency of the replica code generation signal and the phase in the correlation calculation between the PRN code and the replica code. When the frequency of the replica code generation signal and the frequency of the reception signal match with each other and the phases of the PRN code and the replica code match with each other, the integrated correlation value becomes the maximum.

More specifically, a predetermined range of the frequency and the code phase corresponding to the GPS satellite signal as the capture target are set as a search range. Further, the correlation calculation in a phase direction for detecting the start position (code phase) of the PRN code and the correlation calculation in a frequency direction for detecting the frequency are executed in the search range. The search range is determined in a predetermined frequency scanning range centered on 1.57542 [GHz] as the carrier frequency of the GPS satellite signal regarding the frequency, and in a code phase range of 1023 chips as the chip length of the PRN code regarding the code phase.

The positioning calculation section 33 is a processor for performing the positioning calculation for positioning the present location of the portable phone 1 by executing the IMM calculation using the actual measurement value input from the measurement acquisition calculation section 32.

TCXO 40 is a temperature compensated crystal oscillator for generating the oscillation signal at a predetermined oscillation frequency, and outputs the generated oscillation signal to the RF receiving circuit section 21 and the baseband processing circuit section 30.

The host CPU 50 is a processor for integrally controlling each of the sections of the portable phone 1 along various kinds of programs such as a system program stored in the ROM 100. The host CPU 50 makes the display section 70 display the navigation screen plotting the output location input from the positioning calculation section 33.

The operation section 60 is an input device composed, for example, of a touch panel and button switches, and outputs to the host CPU 50 the signals corresponding to the keys and buttons held down. By operating the operation section 60, various kinds of instruction inputs such as a call request, or transmission or receiving request of an electronic mail are executed.

The display section 70 is a display device composed of a liquid crystal display (LCD) or the like, and executing various types of display based on the display signal input from the host CPU 50. On the display section 70, the navigation screen, the time information, and so on are displayed.

The cellular phone antenna 80 is an antenna for performing transmission and reception of the cellular phone radio signal with the wireless base stations installed by the communication service company of the portable phone 1.

The cellular phone radio communication circuit section 90 is a communication circuit section of the cellular phone mainly composed of an RF conversion circuit, a baseband processing circuit, and so on, and executes modulation and demodulation on the cellular phone radio signal, thereby realizing phone calls, transmission and reception of the electronic mails, and so on.

The ROM 100 stores a system program for the host CPU 50 to control the portable phone 1, various programs and data for the host CPU 50 to realize a navigation function, and so on.

The RAM 110 forms a work area for temporarily storing the system program, and various types of processing programs executed by the host CPU 50, and in-process data and process results of the various types of processing.

### 3-2. Data Configuration

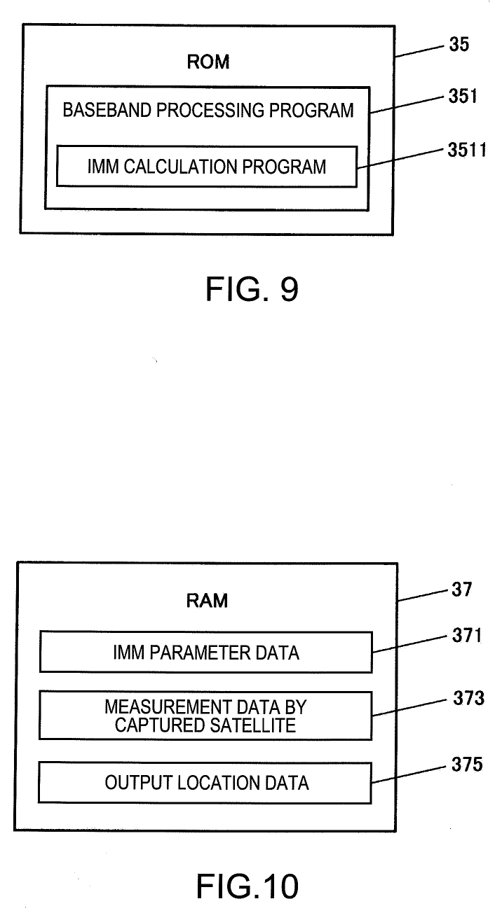

FIG. 9 is a diagram showing an example of the data stored in the ROM 35 in the baseband processing circuit section 30. The ROM 35 stores a baseband processing program 351 retrieved by the positioning calculation section 33 and executed as the baseband process (see FIG. 13). Further, the baseband processing program 351 includes an IMM calculation program 3511 executed as the IMM calculation process (see FIGS. 2 and 3) in a form of a sub-routine.

The baseband process is a process of the positioning calculation section 33 executing the IMM calculation process to determine the output location, and outputting the output location to the host CPU 50. The baseband process will be explained later in detail using a flowchart.

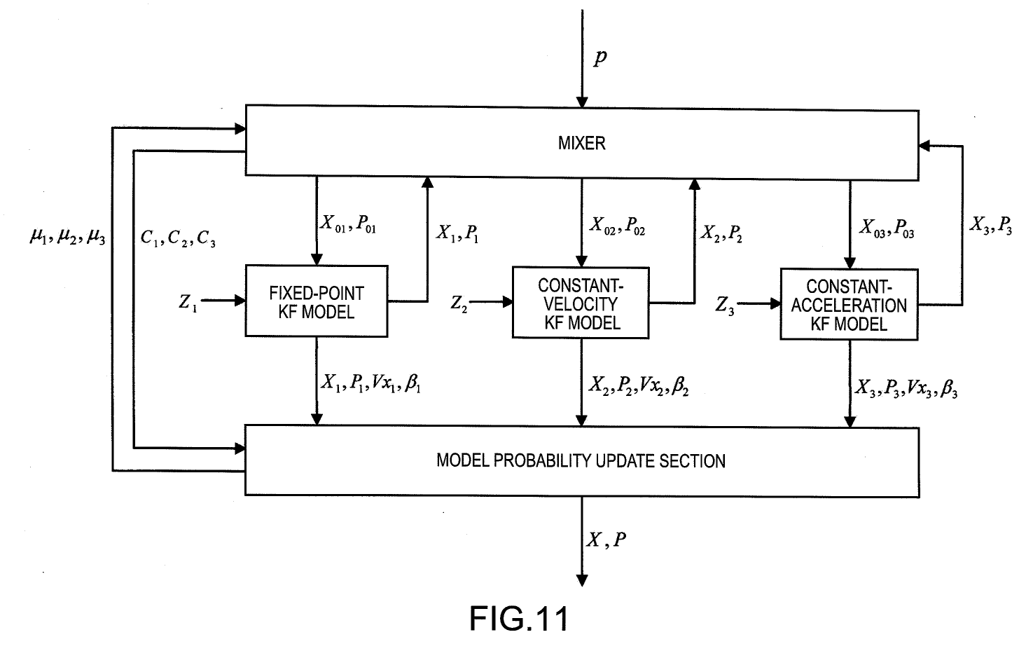

The IMM calculation process is a process of the positioning calculation section 33 combining the processing outputs of the KF process based on a plurality of KF models with the model probabilities thus calculated and updated, thereby determining the output location. In the present embodiment, as shown in FIG. 11, the present location is calculated from the IMM calculation based on the processing outputs of three kinds of KF models, namely a fixed-point KF model indicating that the portable phone 1 is in a stopped state, a constant-velocity KF model indicating that the portable phone 1 is in a constant velocity movement state, and a constant-acceleration KF model indicating that the portable phone 1 is in a constant acceleration state as the KF models indicating the movement states of the portable phone 1.

FIG. 10 is a diagram showing an example of the data to be stored in the RAM 37 in the baseband processing circuit section 30. In the RAM 37, there are stored IMM parameter data 371, measurement data by captured satellite 373, and output location data 375.

The IMM parameter data 371 is the data storing values of various parameters (hereinafter referred to as “IMM parameters”) of the IMM calculation used in the IMM calculation process, and is updated by the positioning calculation section 33 in the IMM calculation process.

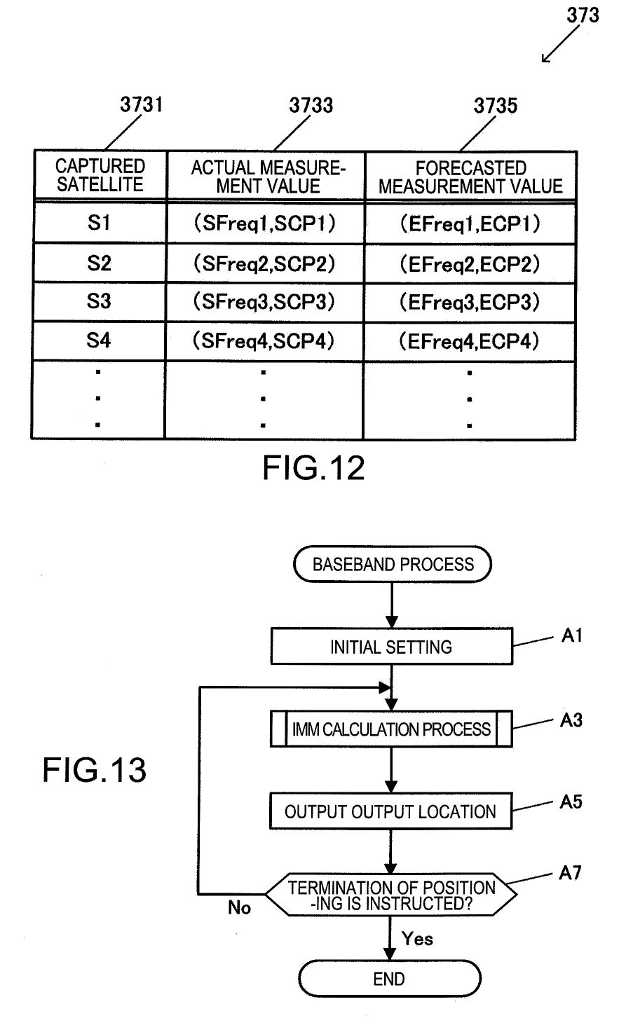

FIG. 12 is a diagram showing a data configuration example of the measurement data by captured satellite 373. The measurement data by captured satellite 373 is the data related to the measurement information used in the IMM calculation process, and is stored so that the captured satellite 3731, the actual measurement value 3733, and the forecasted measurement value 3735 are made to correspond to each other. The captured satellite 3731 stores the numbers of the captured satellites, the actual measurement value 3733 and the forecasted measurement value 3735 store the actual value and the forecasted value of the receiving frequency and the code phase of the GPS satellite signal received from the captured satellite, respectively.

For example, the actual measurement values with respect to the captured satellite S1 are SFreq1 in the reception frequency and SCP1 in the code phase, and the forecasted measurement values are EFreq1 in the reception frequency and ECP1 in the code phase.

In the IMM calculation process, the positioning calculation section 33 obtains the information of the reception frequency and the code phase of the GPS satellite signal, which is thus acquired and calculated by the measurement acquisition calculation section 32, as the actual measurement values. Further, the positioning calculation section 33 forecasts the information of the reception frequency and the code phase of the GPS satellite signal using the forecasted value of the state vector forecasted by the forecasting calculation in the KF process and the observation matrix to determine the forecasted measurement values.

The output location data 375 is the data of the output location determined as the location to be output to the host CPU 50, and is updated by the positioning calculation section 33 in the IMM calculation process.

### 3-3. Process Flow

FIG. 13 is a flowchart showing the flow of the baseband process executed in the portable phone 1 when the positioning calculation section 33 retrieves and executes the baseband processing program 351 stored in the ROM 35. The baseband process is the process execution of which is started by the positioning calculation section 33 in conjunction with the reception of the GPS satellite signal by the RF receiving circuit section 21 when the positioning calculation section 33 detects the fact that the operation for the positioning start instruction is executed on the operation section 60, and is a process executed in parallel with various types of processes such as execution of the various application programs.

It should be noted that it is also possible to arrange that powering ON and OFF of the portable phone 1 and starting and stopping of the GPS are respectively coupled to each other, and the execution of the process is started when the power ON operation of the portable phone 1 is detected. In principle, it is assumed that the positioning calculation is executed every one second. Further, although not particularly explained, it is assumed that during execution of the baseband process described below, there is provided a condition in which receiving of the RF signal by the GPS antenna 10, down-converting to the IF signal by the RF receiving circuit section 21, acquisition and calculation of the information of the reception frequency of the GPS satellite signal and the code phase by the measurement acquisition calculation section 32, and so on are executed as needed.

Firstly, the positioning calculation section 33 executes the initial setting (step A1). Specifically, the positioning calculation section 33 initializes the IMM parameters, and stores them in the IMM parameter data 371 of the RAM 37. Subsequently, the positioning calculation section 33 retrieves and executes the IMM calculation program 3511 stored in the ROM 35, thereby executing the IMM calculation process (step A3).

In the IMM calculation process in the step A3, the positioning calculation section 33 executes the process along the flowchart shown in FIGS. 2 and 3. In this case, the positioning calculation section 33 executes the IMM calculation using 11-dimensional state vector X expressed by the following formula (20) composed of 3-dimensional position (x, y, z), 3-dimensional velocity (u, v, w), 3-dimensional acceleration (aₓ, a_{y}, a_{z}), clock bias b, and clock drift d of the portable phone 1.

X=(x,y,z,u,v,w,aₓ,a_{y},a_{z},b,d) (20)

Further, the positioning calculation section 33 executes the KF process using φ₁ given by the following formula (21) as the state transition matrix for the fixed-point KF model, φ₂ given by the following formula (22) as the state transition matrix for the constant-velocity KF model, and φ₃ given by the following formula (23) as the state transition matrix for the constant-acceleration KF model.

$$\begin{matrix}{φ}_{1} = [ \begin{matrix}1 & 0 & 0 & 0 & 0 & 0 & 0 & 0 & 0 & 0 & 0 \\ 0 & 1 & 0 & 0 & 0 & 0 & 0 & 0 & 0 & 0 & 0 \\ 0 & 0 & 1 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 1 & dt \\ 0 & 0 & 0 & 0 & 0 & 0 & 0 & 0 & 0 & 0 & 1\end{matrix} ] & ( 21 ) \\ {φ}_{2} = [ \begin{matrix}1 & 0 & 0 & dt & 0 & 0 & 0 & 0 & 0 & 0 & 0 \\ 0 & 1 & 0 & 0 & dt & 0 & 0 & 0 & 0 & 0 & 0 \\ 0 & 0 & 1 & 0 & 0 & dt & 0 & 0 & 0 & 0 & 0 \\ 0 & 0 & 0 & 1 & 0 & 0 & 0 & 0 & 0 & 0 & 0 \\ 0 & 0 & 0 & 0 & 1 & 0 & 0 & 0 & 0 & 0 & 0 \\ 0 & 0 & 0 & 0 & 0 & 1 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 1 & dt \\ 0 & 0 & 0 & 0 & 0 & 0 & 0 & 0 & 0 & 0 & 1\end{matrix} ] & ( 22 ) \\ {φ}_{3} = [ \begin{matrix}1 & 0 & 0 & dt & 0 & 0 & {dt}^{2} / 2 & 0 & 0 & 0 & 0 \\ 0 & 1 & 0 & 0 & 0 & 0 & 0 & {dt}^{2} / 2 & 0 & 0 & 0 \\ 0 & 0 & 1 & 0 & 0 & 0 & 0 & 0 & {dt}^{2} / 2 & 0 & 0 \\ 0 & 0 & 0 & 1 & 0 & 0 & 0 & 0 & 0 & 0 & 0 \\ 0 & 0 & 0 & 0 & 1 & 0 & 0 & 0 & 0 & 0 & 0 \\ 0 & 0 & 0 & 0 & 0 & 1 & 0 & 0 & 0 & 0 & 0 \\ 0 & 0 & 0 & 0 & 0 & 0 & 1 & 0 & 0 & 0 & 0 \\ 0 & 0 & 0 & 0 & 0 & 0 & 0 & 1 & 0 & 0 & 0 \\ 0 & 0 & 0 & 0 & 0 & 0 & 0 & 0 & 1 & 0 & 0 \\ 0 & 0 & 0 & 0 & 0 & 0 & 0 & 0 & 0 & 1 & dt \\ 0 & 0 & 0 & 0 & 0 & 0 & 0 & 0 & 0 & 0 & 1\end{matrix} ] & ( 23 )\end{matrix}$$

More specifically, the positioning calculation section 33 calculates the forecasted values X⁻: X⁻₁, X⁻₂, X₋₃ and P⁻: P⁻₁, P⁻₂, P⁻₃ of the state vector and the error covariance along the formulas (6) and (7), respectively, using the state transition matrices φ₁ through φ₃ in the forecasting calculation in the step S11 of the IMM calculation process shown in FIG. 2. It should be noted that each of the state transition matrices is an 11×11 matrix, and the arrangement of rows and columns thereof corresponds to the arrangement of the components of the state vector X in the formula (20).

In the state transition matrix φ₁ of the formula (21), the diagonal components of the 3×3 matrix part corresponding to the 3-dimensional position are set to be 1 while all of the components of the 6×6 matrix part corresponding to the 3-dimensional velocity and acceleration are set to be 0, and therefore, it is understood that it represents the fact that the portable phone 1 is in the stopped state.

In the state transition matrix φ₂ of the formula (22), the diagonal components of the 6×6 matrix part corresponding to the 3-dimensional position and velocity are set to be 1 while all of the components of the 3×3 matrix part corresponding to the 3-dimensional acceleration are set to be 0, and therefore, it is understood that it represents the fact that the portable phone 1 is in the constant velocity movement state.

In the state transition matrix φ₃ of the formula (23), the diagonal components of the 9×9 matrix part corresponding to the 3-dimensional position, velocity, and acceleration are set to be 1, and therefore, it is understood that it represents the fact that the portable phone 1 is in the constant acceleration movement state.

Further, the positioning calculation section 33 executes calculation using the observation matrix H expressed by the following formula (24) with respect to each of the fixed-point KF model, the constant-velocity KF model, and the constant-acceleration KF model.

$${H}_{j} = [ \begin{matrix}{D}_{x} & {D}_{y} & {D}_{z} & 0 & 0 & 0 & 0 & 0 & 0 & 1 & 0 \\ 0 & 0 & 0 & {D}_{x} & {D}_{y} & {D}_{z} & 0 & 0 & 0 & 0 & 1\end{matrix} ] \qquad ( 24 )$$

More specifically, the positioning calculation section 33 calculates the forecasted measurement value HX⁻: H₁X⁻₁, H₂X⁻₂, H₃X⁻₃ using the observation matrix H in the step S15 of the IMM calculation process shown in FIG. 2. Further, in the correction calculation in the step S17, the positioning calculation section 33 calculates the correction values X: X₁, X₂, X₃ and P: P₁, P₂, P₃ of the state vector and the error covariance, respectively, using the observation matrix H along the formulas (8) through (10). Further, in the steps S19 and S21, the positioning calculation section 33 calculates the likelihood index value Vx: Vx₁, Vx₂, Vx₃ and the weighting factor β: β₁, β₂, β₃ along the formulas (11) and (12) using the observation matrix H.

Here, Dₓ, D_{y}, and D_{z} included in the observation matrix H are given respectively by the following formulas (25-1) through (25-3).

$$\begin{matrix}{D}_{x} = \frac{{x}_{u} - {x}_{s}}{R} & ( 25 \text{-} 1 ) \\ {D}_{y} = \frac{{y}_{u} - {y}_{s}}{R} & ( 25 \text{-} 2 ) \\ {D}_{z} = \frac{{z}_{u} - {z}_{s}}{R} & ( 25 \text{-} 3 )\end{matrix}$$

It should be noted that xᵤ, yᵤ, and zᵤ respectively represent the 3-dimensional components of the forecasted position of the portable phone 1 forecasted by the forecasting calculation of the KF process, and xₛ, yₛ, and zₛ respectively represent the 3-dimensional components of the position of the GPS satellite to be the observation object. Further, R represents the distance between the forecasted position of the portable phone 1 and the position of the GPS satellite to be the observation object.

Further, the positioning calculation section 33 calculates the relative values Vx₁−Vx₂, Vx₂−Vx₁, Vx₁−Vx₃, Vx₃−Vx₁, Vx₂−Vx₃, and Vx₃−Vx₂ of the likelihood index values Vx calculated in the step S19 for each of the fixed-point KF model, the constant-velocity KF model, and the constant-acceleration KF model (step S25), and then calculates the model probabilities μ: μ₁, μ₂, μ₃ along the formula (13-2) using the relative values, the weighting factors β: β₁, β₂, β₃ calculated in the step S21, and the normalization constants CN: C₁, C₂, C₃ calculated in the step S3 (steps S27, S29).

Further, the positioning calculation section 33 calculates the state vector X: X₁, X₂, X₃ and the error covariance P: P₁, P₂, P₃ along the formulas (16) and (17) using the model probabilities μ: μ₁, μ₂, μ₃ thus calculated, thereby determining the output value X of the state vector and the output value P of the error covariance (step S31).

After executing the IMM calculation process in the step A3, the positioning calculation section 33 determines the 3-dimensional position (x, y, z) of the portable phone 1 included in the output value X of the state vector determined in the IMM calculation process as the output location, and outputs it to the host CPU 50 (step A5).

Subsequently, the positioning calculation section 33 determines whether or not the user provides the positioning termination instruction via the operation section 60 (step A7), if it is determined that no such instruction has been provided (No in the step A7), the process returns to the step A3. Further, if it is determined that the positioning termination instruction has been provided (Yes in the step A7), the positioning calculation section 33 terminates the baseband process.

### 4. Functions and Advantages

According to the present embodiment, the likelihood index value Vx of each of the Kalman filter processes is calculated, and the relative values of the likelihood index values Vx between the Kalman filter processes are calculated. Further, the model probability μ of each of the Kalman filter processes is calculated using the relative values thus calculated, and the processing outputs of the respective Kalman filter processes are combined using the model probabilities μ, thereby determining the positioning location.

Here, the likelihood index value Vx denotes the exponential part of the likelihood function for calculating the likelihood λ of an external observation amount to be the input value of the Kalman filter. Although the model probability μ in the IMM calculation can be calculated based on the likelihood λ of the external observation value calculated using the likelihood index value Vx, if the likelihood index value Vx has a very small value, the return value of the likelihood λ becomes 0 when attempting to calculate it with a computer, and it is not achievable to correctly obtain the model probability μ.

In order for solving this problem, the relative values of the likelihood index values Vx between a plurality of Kalman filter processes instead of using the likelihood index values Vx directly. This measure is taken focusing attention on the fact that the relative value of the likelihood index values Vx becomes in general the value in the vicinity of 0 even if the individual likelihood index value Vx is a very small value, and when performing calculation while providing the exponential function with the relative value, the result does not become 0. According to the principle described above, it becomes possible to correctly calculate the model probability μ, and as a result, it becomes possible to realize calculation of the correct positioning location.

### 5. Modified Examples

### 5-1. Electronic Apparatus

The invention can be applied to any electronic apparatus providing that the electronic apparatus is equipped with a positioning apparatus. For example, the invention can be applied to a laptop personal computer, a personal digital assistant (PDA), a vehicle navigation apparatus, and so on in a similar manner.

### 5-2. Satellite Positioning System

In the embodiment described above, although the explanations are presented exemplifying the GPS as the satellite positioning system, other satellite positioning systems such as Wide Area Augmentation System (WAAS), Quasi Zenith Satellite System (QZSS), GLObal NAvigation Satellite System (GLONASS), or GALILEO can also be adopted.

### 5-3. Split of Processing

It is possible to arrange that the host CPU 50 executes a part or the whole of the processing to be executed by the positioning calculation section 33. For example, the host CPU 50 executes the IMM calculation to determine the output location using the actual measurement value obtained from the measurement acquisition calculation section 32, and makes the display section 70 display the output location.

What is claimed is:

1. A positioning method adapted to perform an interactive mixing model calculation (IMM calculation) for combining outputs of a plurality of Kalman filter processes while applying weighting of given model probabilities to the outputs in a positioning apparatus, the method comprising:
(a) calculating a first likelihood index value of a first Kalman filter process;
(b) calculating a second likelihood index value of a second Kalman filter process;
(c) calculating a relative value of the first and second likelihood index values;
(d) calculating a first model probability corresponding to the first Kalman filter process and a second model probability corresponding to the second Kalman filter process using the relative value; and
(e) combining outputs of the first and second Kalman filter processes using the first and second model probabilities to execute the positioning.

2. The positioning method according to claim 1, wherein
in step (d), the first and second model probabilities are calculated using a predetermined exponential function having a value decreasing as the relative value becomes smaller.

3. The positioning method according to claim 2, further comprising
(f) determining whether or not the value of the predetermined exponential function calculated using the relative value satisfies a predetermined limit value condition, which is a condition indicating an equivalent value of a limit value,
wherein in step (d), the first and second model probabilities are calculated using the value of the exponential function as a limit value when the predetermined limit value condition is satisfied.

4. The positioning method according to claim 3, wherein
the predetermined limit value condition includes a condition indicating an equivalent value of a maximum value and a condition indicating an equivalent value of a minimum value, and
step (d) includes setting the first and second model probabilities to be either one of 1 and 0 in accordance with whether the condition indicating the equivalent value of the maximum value is satisfied or the condition indicating the equivalent value of the minimum value in the case in which the predetermined limit value condition is satisfied.

5. The positioning method according to claim 1, wherein
the first Kalman filter process is a Kalman filter process corresponding to a constant velocity movement state of the positioning apparatus.

6. A positioning method adapted to perform an interactive mixing model calculation (IMM calculation) for combining outputs of a plurality of Kalman filter processes while applying weighting of given model probabilities to the outputs in a positioning apparatus, the method comprising
(a) calculating a first likelihood index value of a first Kalman filter process;
(b) calculating a second likelihood index value of a second Kalman filter process;
(g) calculating a third likelihood index value of a third Kalman filter process;
(h) calculating relative values of the first, second, and third likelihood index values;
(i) calculating a first model probability corresponding to the first Kalman filter process, a second model probability corresponding to the second Kalman filter process, and a third model probability corresponding to the third Kalman filter process using the relative values; and
(j) combining outputs of the first, second, and third Kalman filter processes using the first, second, and third model probabilities to execute the positioning.

7. The positioning method according to claim 6, wherein
the first Kalman filter process is a Kalman filter process corresponding to a stopped state of the positioning apparatus,
the second Kalman filter process is a Kalman filter process corresponding to a constant velocity movement state of the positioning apparatus, and
the third Kalman filter process is a Kalman filter process corresponding to a constant acceleration movement state of the positioning apparatus.

8. A positioning apparatus adapted to perform interactive mixing model calculation (IMM calculation) for combining outputs of a plurality of Kalman filter processes while applying weighting of given model probabilities to the outputs, comprising
a first index value calculation section adapted to calculate a first likelihood index value of a first Kalman filter process;
a second index value calculation section adapted to calculate a second likelihood index value of a second Kalman filter process;
a relative value calculation section adapted to calculate a relative value of the first and second likelihood index values;
a model probability calculation section adapted to calculate a first model probability corresponding to the first Kalman filter process and a second model probability corresponding to the second Kalman filter process using the relative value; and
a positioning section adapted to combine outputs of the first and second Kalman filter processes using the first and second model probabilities to execute the positioning.
